(19) United States
(12) Patent Application Publication
(10) Pub. No.: US 2006/0012749 A1
(43) Pub. Date: Jan. 19, 2006

(54) Method of manufacturing lens with hold frame, and lens with hold frame

(76) Inventor: Toshiyuki Ai, Tochigi (JP)

Correspondence Address: BIRCH STEWART KOLASCH & BIRCH, PO BOX 747, FALLS CHURCH, VA, 22040-0747, US

(21) Appl. No.: 10/521,560

(22) PCT Filed: Jul. 17, 2003
(86) PCT No.: PCT/JP03/09080

§ 371 Date: Jul. 27, 2005

(30) Foreign Application Priority Data
Jul. 19, 2002 (JP) 2002-210716

(51) Int. Cl. G02C 1/00

(52) U.S. Cl. 351/158

(57) ABSTRACT

A method of manufacturing a lens with a hold frame, and the lens with the hold frame having a lens formed of an alicyclic structure-containing polymer resin and a hold frame for holding the lens which are formed integrally with each other, the method comprising the step of injecting a resin material for lens formed of the alicyclic structure-containing polymer resin and a resin material for the hold frame into the cavity (A) and the cavity (B) of a metal mold having the lens-shaped cavity (A) and the hold frame-shaped cavity (B), respectively, to form the lens in two colors, whereby the lens with the hold frame meeting the requirements for the lens and the hold frame can be manufactured advantageously for industrial production.

### TECHNICAL FIELD

The present invention relates to a method of manufacturing a lens with a holding frame, and to a lens with a holding frame.

### BACKGROUND ART

A lens made of a synthetic resin has been used for optical products such as a camera. A resin lens has high transparency, is lightweight, and has excellent moldability in comparison with a glass lens.

In the case of incorporating a resin lens into an optical product, the lens is secured in a lens barrel or a casing through a holding frame which holds the rim of the lens. Conventionally, such a lens holding structure is formed by separately forming the lens and the holding frame and assembling them. Therefore, manufacturing cost is increased due to the assembly step, or optical performance deteriorates due to occurrence of an installation error of the lens and the holding frame during the assembly step.

As a means to solve such a problem, a method of integrally molding an optical element such as a lens and a lens support (holding frame) by using a double molding (two-color molding) method has been proposed (Japanese Patent Application Laid-open No. 61-256313, Japanese Patent Application Laid-open No. 7-63968, and Japanese Patent Application Laid-open No. 11-221839, for example). These methods suggest use of a polymethacrylate (PMMA) resin, a polycarbonate (PC) resin, or the like as a lens resin material.

However, in double molding using PMMA or PC, when forming a secondary molding after forming a primary molding, the shape of the primary molding may be deformed, or a gap may be, formed between the primary molding and the secondary molding.

An optical product, particularly a portable electronic instrument such as a portable telephone with a camera is used at various locations under various environments. Therefore, a resin lens used for a portable electronic instrument is required to have various characteristics such as high transparency, abrasion resistance, heat resistance, and water resistance. In recent years, a portable electronic instrument has been increasingly reduced in size, weight, and cost. Therefore, development of a technology for manufacturing a smaller and precise resin lens at a reduced manufacturing cost while satisfying all the characteristics required for the resin lens has been demanded.

### BRIEF DESCRIPTION OF THE DRAWINGS

FIG. 1 is a cross-sectional view showing an embodiment of a mold for carrying out a method of manufacturing a lens with a holding frame of the present invention.

FIG. 2 is an enlarged view showing a portion C shown in FIG. 1.

FIG. 3 is an enlarged view showing a portion D shown in FIG. 1.

FIG. 4 shows a lens with a holding frame molded by using the manufacturing method of the present invention, wherein FIG. 4(a) is a top oblique view, and FIG. 4(b) is a bottom oblique view.

FIG. 5 shows an example of a lens with a holding frame of the present invention, wherein FIG. 5(a) is a top view, and FIG. 5(b) is a cross-sectional view along the axis A-A′ shown in FIG. 5(a).

### DISCLOSURE OF THE INVENTION

The present invention has been achieved in view of the above-described situation. An objective of the present invention is to provide a method of advantageously manufacturing a lens with a holding frame which sufficiently satisfies characteristics required for the lens and the holding frame on an industrial scale, and a lens with a holding frame.

In order to achieve the above objective, the present inventor has conducted extensive studies on a method of manufacturing a lens with a holding frame by using the double injection method using a mold including a lens-shaped cavity A and a holding-frame-shaped cavity B.

As a result, the present inventor has found that a lens with a holding frame can be efficiently obtained by injecting a lens resin material including an alicyclic structure-containing polymer resin into the cavity A of the mold and injecting a holding frame resin material into the cavity B to achieve double injection. The present inventor also has found that the resulting lens with a holding frame excels in various characteristics required for a resin lens for an optical product, particularly for a portable electronic instrument. These findings have led to the completion of the present invention.

According to a first aspect of the present invention, there is provided a method of manufacturing a lens with a holding frame, the method comprising providing a mold including a lens-shaped cavity A and a holding-frame-shaped cavity B, and injecting a lens resin material including an alicyclic structure-containing polymer resin into the cavity A and injecting a holding frame resin material into the cavity B to achieve double injection.

In the manufacturing method of the present invention, it is preferable that a difference between molding shrinkage of the holding frame resin material and molding shrinkage of the lens resin material be 0 to 0.2%.

In the manufacturing method of the present invention, it is preferable to inject the lens resin material into the cavity A after injecting the holding frame resin material into the cavity B. In this case, it is preferable that a thermal deformation temperature of the holding frame resin material be equal to or higher than a thermal deformation temperature of the lens resin material.

In the manufacturing method of the present invention, it is preferable to use a mold of which gates for injecting the resin materials into the cavity A and the cavity B are pin-point gates. It is still more preferable to use a mold including a tab ejector.

According to a second aspect of the present invention, there is provided a lens with a holding frame, comprising a lens formed of an alicyclic structure-containing polymer resin, and a holding frame for holding the lens, the lens and the holding frame being integrally formed.

In the lens with a holding frame of the present invention, it is preferable that a protrusion be provided on an inner circumferential surface of the holding frame and the lens be secured by the protrusion on the inner circumferential surface. It is still more preferable that the protrusion on the inner circumferential surface of the holding frame be an undercut. It is still more preferable that the protrusion on the inner circumferential surface of the holding frame be a peak-shaped protrusion formed around the inner circumferential surface of the holding frame.

The lens with a holding frame of the present invention can be suitably used for a portable electronic instrument.

### BEST MODE FOR CARRYING OUT THE INVENTION

The present invention is described below in detail in the order of (A) a lens resin material, (B) a holding frame resin material, (C) a mold, (D) a method of manufacturing a lens with a holding frame, (E) a lens with a holding frame, and (F) a portable electronic instrument.

(A) Lens Resin Material

The lens resin material used in the present invention includes an alicyclic structure-containing polymer resin.

The alicyclic structure-containing polymer resin used in the present invention is a thermoplastic resin in which a repeating unit of the polymer resin includes an alicyclic structure. As the alicyclic structure-containing polymer resin, a polymer resin including an alicyclic structure in the main chain and a polymer resin including an alicyclic structure in the side chain may be used.

As examples of the alicyclic structure, a cycloalkane structure, a cycloalkene structure, and the like can be given. Of these, the cycloalkane structure is preferable from the viewpoint of thermal stability and the like. The number of carbon atoms which make up the alicyclic structure is not particularly limited. The number of carbon atoms is usually 4 to 30, preferably 5 to 20, and still more preferably 5 to 15. If the number of carbon atoms which make up the alicyclic structure is within this range, a resin lens having excellent heat resistance and flexibility can be obtained.

The content of the repeating unit including the alicyclic structure in the alicyclic structure-containing polymer resin may be arbitrarily selected depending on the use. The content is usually 50 wt % or more, preferably 70 wt % or more, and still more preferably 90 wt % or more. If the content of the repeating unit including the alicyclic structure is too low, heat resistance may be decreased. A repeating unit other than the repeating unit including the alicyclic structure in the alicyclic structure-containing polymer resin is arbitrarily selected depending on the use.

As specific examples of the alicyclic structure-containing polymer resin, (1) a norbornene polymer, (2) a monocyclic olefin polymer, (3) a cyclic conjugated diene polymer, (4) a vinyl alicyclic hydrocarbon polymer, hydrogenated products of the polymers (1) to (4), and the like can be given. Of these, the hydrogenated product of the norbornene polymer, the vinyl alicyclic hydrocarbon polymer, and the hydrogenated product of the vinyl alicyclic hydrocarbon polymer are preferable due to excellent heat resistance and mechanical strength, with the hydrogenated product of the norbornene polymer being still more preferable.

The norbornene polymer used in the present invention is a polymer of monomers mainly consisting of norbornene monomers such as norbornene and its derivative, tetracyclododecene and its derivative, dicyclopentadiene and its derivative, and methanotetrahydrofluorene and its derivative.

As specific examples of the norbornene polymer, (i) a ring-opening polymer of norbornene monomers, (ii) a ring-opening polymer of a norbornene monomer and a monomer copolymerizable with the norbornene monomer, (iii) an addition polymer of norbornene monomers, (iv) an addition polymer of a norbornene monomer and a monomer copolymerizable with the norbornene monomer, hydrogenated products of the polymers (i) to (iv), and the like can be given.

As examples of the norbornene monomer, bicyclo[2.2.1]hepta-2-ene (common name: norbornene), tricyclo[4.3.0.1^{2,5}]deca-3,7-diene (common name: dicyclopentadiene), 7,8-benzotricyclo[4.3.0.1^{2,5}]deca-3-ene (common name: methanotetrahydrofluorene), tetracyclo[4.4.0.1^{2,5}0.1^{7,10}]dodeca-3-ene (common name: tetracyclododecene), derivatives (derivative including a substituent on the ring, for example) of these compounds, and the like can be given. As examples of the substituent, an alkyl group, an alkylene group, an alkoxycarbonyl group, a carboxyl group, and the like can be given. A plurality of the same or different substituents may be bonded to the ring. The norbornene monomers may be used either individually or in combination of two or more.

As examples of the monomer ring-opening copolymerizable with the norbornene monomer, monocyclic olefins such as cyclohexene, cycloheptene, and cyclooctene, and derivatives thereof; cyclic conjugated dienes such as cyclohexadiene and cycloheptadiene, and derivatives thereof; and the like can be given.

The ring-opening polymer of the norbornene monomers and the ring-opening polymer of the norbornene monomer and the monomer copolymerizable with the norbornene monomer may be obtained by (co)polymerizing the monomers in the presence of a ring-opening polymerization catalyst.

As examples of the ring-opening polymerization catalyst, a catalyst including a halide of a metal such as ruthenium or osmium, a sulfate or an acetylacetone compound, and a reducing agent; a catalyst including a halide of a metal such as titanium, zirconium, tungsten, or molybdenum, or an acetylacetone compound, and an organoaluminum compound; and the like can be given.

The addition polymer of the norbornene monomers and the addition polymer of the norbornene monomer and the monomer copolymerizable with the norbornene monomer may be obtained by polymerizing the monomers in the presence of an addition polymerization catalyst.

As the addition polymerization catalyst, a catalyst including a compound of a metal such as titanium, zirconium, or vanadium and an organoaluminum compound, and the like can be given.

As examples of the monomer addition-copolymerizable with the norbornene monomer, α-olefins having 2 to 20 carbon atoms such as ethylene, propylene, 1-butene, 1-pentene, 1-octene, 1-decene, 1-dodecene, 1-tetradecene, 1-hexadecene, 1-octadecene, and 1-eicosene, and derivatives thereof; cycloolefins such as cyclobutene, cyclopentene, cyclohexene, cyclooctene, 3a,5,6,7a-tetrahydro-4,7-methano-1H-indene, and derivatives thereof; nonconjugated dienes such as 1,4-hexadiene, 4-methyl-1,4-hexadiene, 5-methyl-1,4-hexadiene, and 1,7-octadiene; and the like can be given. These monomers may be used either individually or in combination of two or more. Of these, α-olefins are preferable, with ethylene being still more preferable.

As examples of the monocyclic olefin polymer used in the present invention, addition polymers of cyclohexene, cycloheptene, and cyclooctene, and the like can be given.

As examples of the cyclic conjugated diene polymer used in the present invention, 1,2-addition or 1,4-addition polymers of cyclic conjugated diene monomers such as cyclopentadiene and cyclohexadiene, and the like can be given.

The molecular weight of the norbornene polymer, the monocyclic olefin polymer, and the cyclic conjugated diene polymer is arbitrarily selected depending on the use. The molecular weight is usually 10,000 to 100,000, preferably 25,000 to 80,000, and still more preferably 25,000 to 50,000 as a polyisoprene or polystyrene-reduced weight average molecular weight (Mw) measured by gel permeation chromatography (hereinafter abbreviated as “GPC”) using cyclohexane (or toluene when the polymer resin is not dissolved in cyclohexane) as a solvent. If the weight average molecular weight is within this range, mechanical strength and moldability of the resin material are highly balanced.

The vinyl alicyclic hydrocarbon polymer is a polymer including a repeating unit derived from a vinylcycloalkane or vinylcycloalkene. As examples of the vinyl alicyclic hydrocarbon polymer, polymers of vinyl alicyclic hydrocarbon compounds such as a vinylcycloalkane such as vinylcyclohexane and a vinylcycloalkene such as vinylcyclohexene, and hydrogenated products thereof; aromatic-portion hydrogenated products of polymers of vinyl aromatic hydrocarbon compounds such as styrene and α-methylstyrene; and the like can be given.

The vinyl alicyclic hydrocarbon polymer may be a copolymer such as a random copolymer or a block copolymer of a vinyl alicyclic hydrocarbon compound or a vinyl aromatic hydrocarbon compound and a monomer copolymerizable with these monomers, or a hydrogenated product of the copolymer. As examples of block copolymerization, diblock, triblock, or higher multiblock copolymerization, gradient block copolymerization, and the like can be given. However, block copolymerization is not particularly limited.

The molecular weight of the vinyl alicyclic hydrocarbon polymer is arbitrarily selected depending on the use. The molecular weight is usually 10,000 to 300,000, preferably 15,000 to 250,000, and still more preferably 20,000 to 200,000 as a polyisoprene or polystyrene-reduced weight average molecular weight (Mw) measured by GPC using cyclohexane (or toluene when the polymer resin is not dissolved in cyclohexane) as a solvent. In this case, mechanical strength and moldability of the resulting molding are highly balanced.

The above-mentioned polymer hydrogenated product may be obtained by adding a conventional hydrogenation catalyst including a transition metal such as nickel or palladium to an unhydrogenated polymer solution and hydrogenating the carbon-carbon unsaturated bond in an amount of preferably 90% or more. In general, a resin excelling in stability against heat and light can be obtained as the hydrogenation rate is higher.

The glass transition temperature of the alicyclic structure-containing polymer resin used in the present invention may be arbitrarily selected depending on the use. The glass transition temperature is preferably 80° C. or more, and still more preferably 100 to 250° C. A resin lens including an alicyclic structure-containing polymer resin of which the glass transition temperature is within this range does not produce deformation and stress during use at a high temperature to exhibit excellent durability.

The molecular weight distribution (weight average molecular weight (Mw)/number average molecular weight (Mn)) of the alicyclic structure-containing polymer resin used in the present invention is not particularly limited, but is usually 1.0 to 10.0, preferably 1.1 to 4.0, and still more preferably 1.1 to 3.5. The alicyclic structure-containing polymer resin suitably used in the present invention preferably has a molding shrinkage of 0.6 to 0.7%.

A conventional additive such as an antioxidant, a UV absorber, a light stabilizer, an antistatic agent, a flame retardant, an impact resistance improver, or a lubricant may be added to the lens resin material used in the present invention in addition to the alicyclic structure-containing polymer resin in such an amount that the effect of the present invention is not impaired.

The lens resin material may be prepared by using (a) a method of mixing the alicyclic structure-containing polymer resin together with an additive as required by using a stirrer such as a ribbon blender, a tumbler blender, or a Henschel mixer, and melting and mixing the resulting mixture by using a melt mixer such as an extruder, a Banbury mixer or a double roller, (b) a method of dissolving the alicyclic structure-containing polymer resin in an organic solvent such as an aliphatic hydrocarbon solvent or an aromatic hydrocarbon solvent to obtain a polymer solution, adding an additive as required, and mixing the polymer solution, or the like.

(B) Holding Frame Resin Material

There are no specific limitations to the holding frame resin material used in the present invention. However, it is preferable to use a resin having a high modulus of elasticity and excellent lubricity. As examples of the holding frame resin material, the above-mentioned alicyclic structure-containing polymer resin, polycarbonate (PC), polyphenylene sulfide (PPS), polysulfone, an acrylonitrile-butadiene-styrene copolymer (ABS resin), an acrylate-styrene-acrylonitrile copolymer (ASA), an acrylonitrile-ethylene-styrene copolymer (AES resin), a blended product of polycarbonate and an ABS resin, products obtained by adding a glass filler or the like to these resins, and the like can be given. These materials may be used either individually or in combination of two or more.

The difference between the molding shrinkage of the holding frame resin material and the molding shrinkage of the lens resin material is preferably 0 to 0.2%, still more preferably 0 to 0.1%, and particularly preferably 0 to 0.05%. A primary molding can be prevented from being damaged or a burr can be prevented from occurring due to occurrence of a gap when molding a secondary molding after reversing the mold by reducing the difference in molding shrinkage.

As preferable specific examples of the holding frame resin material, polycarbonate (PC), a material obtained by mixing a glass filler into PC in an amount of 20 to 30 wt %, a material obtained by mixing a glass filler into ABS in an amount of 20 to 30 wt %, and the like can be given. In the present invention, a resin having a molding shrinkage of 0.6 to 0.7% is preferable as the holding frame resin.

(C) Mold

The manufacturing method of the present invention uses a mold including a lens-shaped cavity A and a holding-frame-shaped cavity B. The lens shape is not particularly limited. The lens shape may be spherical or aspherical. The lens shape may be a lens shape having a positive power or a lens shape having a negative power.

In the mold used in the present invention, it is preferable that gates for injecting the resin materials into the cavity A and the cavity B be pin-point gates.

A conventional resin lens has been manufactured by using a mold having a side gate. This is because a molding variation may occur when using a mold having a pin-point gate since a conventional lens resin material such as PMMA has poor flowability. According to the present invention, since the lens resin material including the alicyclic structure-containing polymer resin having excellent flowability is used, a molding variation does not occur even if a mold having a pin-point gate is used.

In the case of using a mold having a side gate, since a notch or a hole must be formed in a part of the holding frame, shading properties may be impaired. In the present invention, since it is unnecessary to form a notch or a hole in the holding frame, the same performance as in the case of separately molding the lens and the holding frame and assembling them can be obtained.

It is preferable that the pin-point gate be disposed at the rim of the lens. In general, since only almost the optical center of the lens is used, the performance of the lens is not affected by disposing the pin-point gate at the rim of the lens. Moreover, since the pin-point gate allows gate cutting to be performed at the same time as release from the mold, the steps can be simplified and the manufacturing speed can be increased.

The mold used in the present invention preferably includes a tab ejector. Since the product can be removed from the mold through a tab using the tab ejector, the product can be prevented from being damaged when removing the product from the mold.

(D) Manufacture of Lens with Holding Frame

The manufacturing method of the present invention includes providing a mold including a lens-shaped cavity A and a holding-frame-shaped cavity B, and injecting a lens resin material including an alicyclic structure-containing polymer resin into the cavity A and injecting a holding frame resin material into the cavity B to achieve double injection.

In the manufacturing method of the present invention, it is preferable to inject the lens resin material into the cavity A after injecting the holding frame resin material into the cavity B. A lens with a holding frame having high lens profile accuracy can be obtained without causing the lens to be affected by heat from the holding frame resin material by molding the lens after molding the holding frame. The profile accuracy of the lens with a holding frame obtained by using the manufacturing method of the present invention is such that the P-V value is 1.5 μm or less, preferably 1.0 μm or less, and still more preferably 0.5 μm or less.

It is preferable to use a holding frame resin material having a thermal deformation temperature equal to or higher than the thermal deformation temperature of the lens resin material. In the case of molding the holding frame as a primary molding and then molding the lens as a secondary molding, use of a holding frame resin material having a thermal deformation temperature higher than the thermal deformation temperature of the lens resin material prevents the holding frame from being melted due to heat from the lens resin material to affect the performance and appearance of the lens.

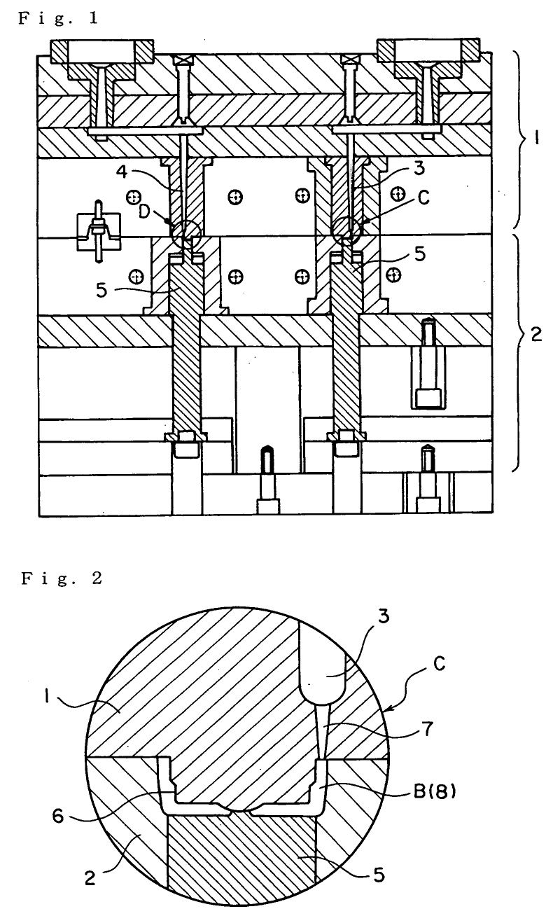

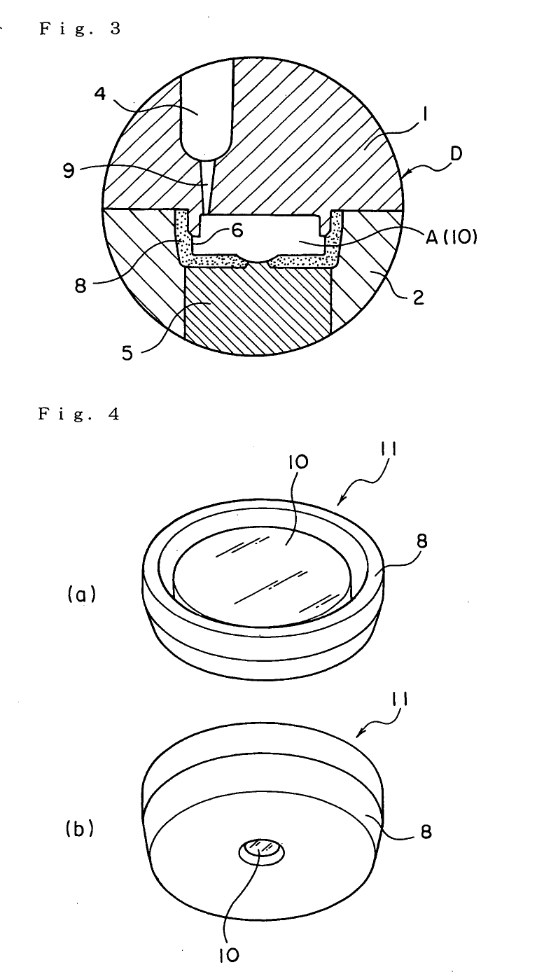

FIG. 1 shows an embodiment of the mold used in the present invention. FIGS. 2 and 3 are enlarged views respectively showing a portion C and a portion D shown in FIG. 1. This mold includes an upper mold 1 and a lower mold 2. The upper mold 1 includes a spool 3 for molding a holding frame and a spool 4 for molding a lens, and the lower mold 2 includes a holding frame ejector 5.

As shown in FIG. 2, the holding frame cavity B is formed between the upper mold 1 and the lower mold 2. In this case, a tapered section (undercut section) 6 extending downward is formed on the inner circumferential wall of the cavity B.

The holding frame resin material is injected into the cavity B from the spool 3 through a pin-point gate 7. After a holding frame 8 has been molded (cured), the upper mold 1 and the lower mold 2 are separated. In this case, since the holding frame resin has elasticity, the undercut section 6 formed in the holding frame 8 allows the upper mold 1 to be removed without damaging the holding frame 8.

The lower mold 2 is moved to the left in FIG. 1 with respect to the upper mold 1, and is stopped in a state in which the lower mold 2 has reached a predetermined position with respect to a pin-point gate 9 of the spool 4, as shown in FIG. 3. The lens cavity A is formed between the holding frame 8 and the upper mold 1 by engaging the upper mold 1 with the lower mold 2.

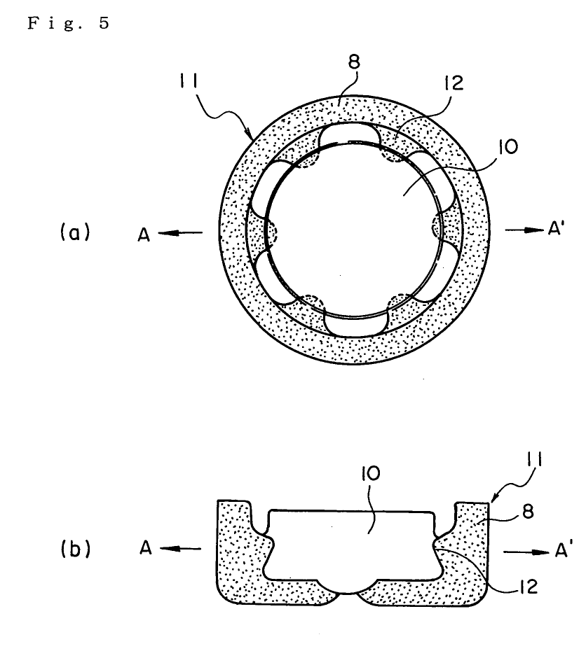

The lens resin material is then injected into the cavity A from the spool 4 through the pin-point gate 9. After a lens 10 has been molded (cured), the upper mold 1 and the lower mold 2 are separated. A lens 11 with a holding frame having a shape as shown in FIG. 4 can be removed from the mold by using the ejector 5.

In the present invention, the lens with a holding frame can be prevented from being damaged by providing a tab to the holding frame of the lens with a holding frame, providing a tab ejector (ejector pin) to the mold, and causing the tab to be pushed by using the tab ejector after molding. The tab installation position is not particularly limited insofar as the function of the lens is not impaired. The tab installation position is usually the boundary between the upper mold 1 and the lower mold 2 of the mold. The tab may be removed by using a cutting device after removing the molding from the mold.

(E) Lens with Holding Frame

The lens with a holding frame of the present invention includes a lens formed of an alicyclic structure-containing polymer resin and a holding frame for holding the lens. As the alicyclic structure-containing polymer resin, the alicyclic structure-containing polymer resins listed in the section “Lens Resin Material” can be given. As the resin material for forming the holding frame, the materials listed in the section “Holding Frame Resin Material” can be given.

The lens with a holding frame of the present invention excels in various characteristics such as transparency, abrasion resistance, heat resistance, and water resistance since the lens is made of the alicyclic structure-containing polymer resin.

A method of manufacturing the lens with a holding frame of the present invention is not particularly limited. The lens with a holding frame may be formed by using a conventional molding method. As the molding method, an injection molding method, an injection compression molding method, and the like can be given. It is preferable that the lens with a holding frame be manufactured by using the manufacturing method of the present invention since production efficiency is high and a lens with a holding frame in which the holding frame and the lens are securely bonded can be manufactured.

The lens with a holding frame of the present invention is not limited to the shape of the lens. The lens may be a spherical lens or an aspherical lens. The lens may be a lens having a positive power (convex lens) or a lens having a negative power (concave lens). The shape of the holding frame is not particularly limited insofar as the holding frame can securely hold the lens.

In the lens with a holding frame of the present invention, it is preferable that a protrusion be provided on the inner circumferential surface of the holding frame and the lens be secured by the protrusion on the inner circumferential surface of the holding frame. A lens with a holding frame in which the lens is firmly secured can be obtained by providing the protrusion on the inner circumferential surface of the holding frame.

In the lens with a holding frame of the present invention, it is preferable that the protrusion provided on the inner circumferential surface of the holding frame be an undercut. It is still more preferable that the protrusion provided on the inner circumferential surface of the holding frame be a peak-shaped protrusion formed around the inner circumferential surface. In the case of injecting the lens resin material onto the holding frame molded in advance, if the adhesion between the lens and the holding frame is low, the lens may be moved or removed from the holding frame. The holding frame and the lens can be securely bonded by forming the undercut section on the inner circumferential surface of the holding frame. The lens can be more securely bonded to the holding frame by forming the peak-shaped protrusion as the protrusion.

FIG. 5 shows an example of a lens with a holding frame including a peak-shaped protrusion on the inner circumferential surface. FIG. 5(a) is a top view of the lens with a holding frame including a peak-shaped protrusion 12 on the inner circumferential surface, and FIG. 5(b) is a cross-sectional view along the line A-A′ shown in FIG. 5(a). As shown in FIGS. 5(a) and (b), the peak-shaped protrusion is formed around the inner circumferential surface of the holding frame, and is an undercut. It suffices that the peak-shaped protrusion be formed around the inner circumferential surface. The number of protrusions is not limited. The number of protrusions may be six as shown in FIG. 5(a), or the protrusion may be continuously formed around the inner circumferential surface.

The size of the lens with a holding frame of the present invention is not particularly limited. The lens with a holding frame of the present invention can be suitably used for various optical products, particularly for portable electronic instruments.

### INDUSTRIAL APPLICABILITY

According to the method of manufacturing a lens with a holding frame of the present invention, a lens with a holding frame in which the lens and the holding frame, each having suitable characteristics, are integrated can be advantageously manufactured on an industrial scale.

The lens with a holding frame of the present invention excels in various characteristics required for an optical material such as transparency, abrasion resistance, heat resistance, and water resistance, since the lens is formed of an alicyclic structure-containing polymer resin. In the lens with a holding frame of the present invention, the lens is firmly secured by the protrusion provided on the inner circumferential surface of the holding frame. In the case where the protrusion is an undercut, and is preferably a peak-shaped protrusion formed around the inner circumferential surface of the holding frame, the lens is more firmly secured to the holding frame.

According to the above-described features, the lens with a holding frame of the present invention can be suitably used as a lens for a portable electronic instrument such as a portable telephone.

1. A method of manufacturing a lens with a holding frame, the method comprising providing a mold including a lens-shaped cavity A and a holding-frame-shaped cavity B, and injecting a lens resin material including an alicyclic structure-containing polymer resin into the cavity A and injecting a holding frame resin material into the cavity B to achieve double injection.

2. The method of manufacturing a lens with a holding frame according to claim 1, wherein a difference between molding shrinkage of the holding frame resin material and molding shrinkage of the lens resin material is 0 to 0.2%.

3. The method of manufacturing a lens with a holding frame according to claim 1 or 2, wherein the lens resin material is injected into the cavity A after injecting the holding frame resin material into the cavity B.

4. The method of manufacturing a lens with a holding frame according to claim 1, wherein a thermal deformation temperature of the holding frame resin material is equal to or higher than a thermal deformation temperature of the lens resin material.

5. The method of manufacturing a lens with a holding frame according to claim 1, comprising using a mold of which gates for injecting the resin materials into the cavity A and the cavity B are pin-point gates.

6. The method of manufacturing a lens with a holding frame according to claim 1, comprising using a mold including a tab ejector.

7. A lens with a holding frame, comprising a lens formed of an alicyclic structure-containing polymer resin, and a holding frame for holding the lens, the lens and the holding frame being integrally formed.

8. The lens with a holding frame according to claim 7, comprising a protrusion provided on an inner circumferential surface of the holding frame, wherein the lens is secured by the protrusion on the inner circumferential surface.

9. The lens with a holding frame according to claim 8, wherein the protrusion on the inner circumferential surface of the holding frame is an undercut.

10. The lens with a holding frame according to claim 8 or 9, wherein the protrusion on the inner circumferential surface of the holding frame is a peak-shaped protrusion formed around the inner circumferential surface of the holding frame.
